(19) United States
(12) Patent Application Publication
(10) Pub. No.: US 2026/0037728 A1
(43) Pub. Date: Feb. 5, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/351,547

(22) Filed: Oct. 7, 2025

Related U.S. Application Data
(63) Continuation of application No. PCT/JP2024/007689, filed on Mar. 1, 2024.

(30) Foreign Application Priority Data
Apr. 26, 2023 (JP) 2023-072601

(51) Int. Cl. G06F 40/279; G06F 40/30

(52) U.S. Cl. CPC G06F 40/279; G06F 40/30

(57) ABSTRACT

An information processing method is an information processing method for weighting an evaluation item for evaluating an evaluation target, and includes: obtaining, as text information, information expressed by one or more persons in an organization to which the one or more persons belong; obtaining one or more topics related to the text information by analyzing the text information; and weighting the evaluation item based on one or more similarity degrees between the evaluation item and the one or more topics.

### CROSS REFERENCE TO RELATED APPLICATIONS

This is a continuation application of PCT International Application No. PCT/JP2024/007689 filed on March 01, 2024, designating the United States of America, which is based on and claims priority of Japanese Patent Application No. 2023-072601 filed on April 26, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

Patent Literature (PTL) 1 discloses an evaluation support device that provides an evaluation result for an evaluation target. This evaluation support device calculates, for each evaluation item, variation in a degree of dispersion of values of the evaluation item, calculates, for each evaluation item, a standardized value of the variation in the degree of dispersion, and outputs an evaluation result by using the variation of the degree of dispersion and the above-described standardized value.

### Citation List

### Patent Literature

PTL 1: Japanese Unexamined Patent Application Publication No.2016-218518

### SUMMARY

### Technical Problem

In an organization such as a company, an evaluation target such as a theme of research and development is evaluated. However, for example, when a plurality of evaluation items for evaluating an evaluation target have the same degree of importance, the evaluation target cannot be always evaluated in accordance with a value system of the organization, a requirement expected for the organization, or an organizational image.

The present disclosure provides an information processing method or the like in which an evaluation target can be evaluated in accordance with a value system of an organization, a requirement expected for the organization, or an organizational image.

### Solution to Problem

An information processing method according to an aspect of the present disclosure is an information processing method for weighting an evaluation item for evaluating an evaluation target, and includes: obtaining, as text information, information expressed by one or more persons in an organization to which the one or more persons belong; obtaining one or more topics related to the text information by analyzing the text information; and weighting the evaluation item based on one or more similarity degrees between the evaluation item and the one or more topics.

An information processing system according to an aspect of the present disclosure is an information processing system for weighting an evaluation item for evaluating an evaluation target, and includes: a text information obtainer that obtains, as text information, information expressed by one or more persons in an organization to which the one or more persons belong; a topic obtainer that obtains one or more topics related to the text information by analyzing the text information; and a weighting unit that weights the evaluation item based on one or more similarity degrees between the evaluation item and the one or more topics.

A recording medium according to an aspect of the present disclosure is a non-transitory computer-readable recording medium having recorded thereon a program for causing a computer to execute the above-described information processing method.

### Advantageous Effects

With an information processing method or the like according to an aspect of the present disclosure, an evaluation target can be evaluated in accordance with a value system of an organization or the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an information processing system according to an embodiment.

FIG. 2 illustrates a block configuration of the information processing system according to the embodiment and an information processing device included in the information processing system.

FIG. 3 illustrates an overview of processes performed by the information processing device.

FIG. 4 illustrates text information obtained from information expressed by persons, and topics extracted from the text information.

FIG. 5 illustrates an example of topic modeling used for analyzing text information.

FIG. 6 illustrates an example of evaluation items for evaluating an evaluation target.

FIG. 7 illustrates an example in which the evaluation items are weighted based on topics.

FIG. 8 illustrates another example of topic modeling.

FIG. 9 is a flowchart illustrating an information processing method according to the embodiment.

### DESCRIPTION OF EMBODIMENT

An information processing method according to the present disclosure is a method in which an evaluation target can be evaluated in accordance with a value system of an organization or the like.

The evaluation target is a matter to be evaluated, and is, for example, a theme of research and development that is promoted by a company with investments for the future. The evaluation target may include a project implemented by members from a plurality of organizations, a group activity within an organization, a theme of a personal goal, etc.

The evaluation target is, for example, evaluated by using evaluation items such as a business strategic characteristic, a technological strength, technological maturity, and the like. However, for example, when a plurality of evaluation items for evaluating an evaluation target have the same degree of importance, the evaluation target cannot be always evaluated in accordance with a value system of an organization, a requirement expected for the organization, or an organizational image. Then, it is conceivable to set the degree of importance of each evaluation item in accordance with: a value system of an organization that is developed based on various circumstances of the world, social or customer needs, corporate philosophy, a corporate vision, or the like; the requirement expected for the organization; or an organizational image.

The information processing method or the like according to the present disclosure includes the following information processes or the like for weighting an evaluation item for evaluating an evaluation target.

An information processing method according to Example 1 is an information processing method for weighting an evaluation item for evaluating an evaluation target, and includes: obtaining, as text information, information expressed by one or more persons in an organization to which the one or more persons belong; obtaining one or more topics related to the text information by analyzing the text information; and weighting the evaluation item based on one or more similarity degrees between the evaluation item and the one or more topics.

Thus, by weighting the evaluation item based on the one or more similarity degrees between the evaluation item and the one or more topics obtained from the text information, the evaluation target can be evaluated in accordance with a value system of the organization, a requirement expected for the organization, or an organizational image.

Moreover, an information processing method according to Example 2 is the information processing method according to Example 1, and in the weighting, a degree of importance of the evaluation item may be derived based on the one or more similarity degrees and a probability of each of the one or more topics belonging to the text information, and the evaluation item may be weighted according to the degree of importance.

Thus, by deriving the degree of importance of the evaluation item based on the above-described one or more similarity degrees and the probability of each of the one or more topics belonging to the text information, the accuracy of weighting of the evaluation item can be improved. Accordingly, the evaluation target can be evaluated in accordance with the value system of the organization or the like.

Moreover, an information processing method according to Example 3 is the information processing method according to Example 1 or 2, the one or more topics obtained in the obtaining of one or more topics may be a plurality of topics related to the text information, and in the weighting, similarity degrees between the evaluation item and the plurality of topics may be obtained, a total similarity degree between the evaluation item and the plurality of topics may be obtained based on the similarity degrees, and the evaluation item may be weighted based on the total similarity degree.

Thus, by weighting the evaluation item based on the total similarity degree between the evaluation item and the plurality of topics, the evaluation target can be evaluated in accordance with the value system of the organization.

Moreover, an information processing method according to Example 4 is the information processing method according to any one of Examples 1 to 3, and the text information may be information expressed by the one or more persons when a plurality of persons including the one or more persons communicate with each other.

Accordingly, the evaluation item can be weighted based on information expressed when the plurality of persons communicate with each other. Thus, the evaluation target can be evaluated in accordance with the value system of the organization or the like.

Moreover, an information processing method according to Example 5 is the information processing method according to any one of Example 1 to 4, and the text information may be information obtained from information expressed by the one or more persons in at least one of a meeting, an online chat, or an e-mail transmission within the organization.

Accordingly, the evaluation item can be weighted based on information expressed in at least one of an online meeting, a face-to-face meeting, a hybrid meeting, an online chat, or an email transmission withing the organization. Thus, the evaluation target can be evaluated in accordance with the value system of the organization or the like.

Moreover, an information processing method according to Example 6 is the information processing method according to any one of Examples 1 to 5, and in the obtaining of one or more topics, the one or more topics may be obtained by analyzing a latent meaning of the text information using topic modeling.

Thus, one or more topics that match the content of the text information can be obtained by analyzing the latent meaning of the text information using topic modeling for statistical latent meaning analysis, and the evaluation item can be weighted based on the one or more topics. Accordingly, the evaluation target can be evaluated in accordance with the value system of the organization or the like.

Moreover, an information processing method according to Example 7 is the information processing method according to any one of Examples 1 to 5, and in the obtaining of one or more topics, the text information may be analyzed by obtaining a total number of appearances of each of a plurality of words in the text information and one or more words each having a large number of appearances among the plurality of words may be obtained as the one or more topics.

Thus, by obtaining a total number of appearances of each of a plurality of words in the text information and analyzing the text information, one or more topics can be obtained based on the total number of appearances of each of the plurality of words and the evaluation item can be weighted based on the one or more topics. Accordingly, the evaluation target can be evaluated in accordance with the value system of the organization or the like.

Moreover, an information processing method according to Example 8 is the information processing method according to any one of Examples 1 to 7, and in the obtaining of one or more topics, the one or more topics may be obtained by excluding, from a plurality of topics related to the text information, a topic that cannot be related to the evaluation item.

Thus, by excluding a topic that cannot be related to the evaluation item, only one or more topics related to the evaluation item can be obtained and the evaluation item can be weighted based on the one or more topics. Accordingly, the evaluation target can be evaluated in accordance with the value system of the organization or the like.

Moreover, an information processing method according to Example 9 is the information processing method according to any one of Examples 1 to 7, and in the obtaining of one or more topics, a determination may be made, for each of a plurality of words included in the text information, as to whether the word is based on positive information or negative information and the one or more topics may be obtained based on the determination.

Accordingly, for example, it is possible to cause the text information to be analyzed based on positive information and not to be analyzed based on negative information. Therefore, the evaluation item can be weighted by using one or more topics based on positive information. Accordingly, the evaluation target can be evaluated in accordance with the value system of the organization or the like.

Moreover, an information processing method according to Example 10 is the information processing method according to Example 9, and in the obtaining of one or more topics, when information included in the text information is determined to be based on negative information, the text information is not necessarily analyzed based on the negative information.

Thus, by not analyzing text information that is based on negative information, the evaluation item can be weighted without using a topic based on negative information. Accordingly, the evaluation target can be evaluated in accordance with the value system of the organization or the like.

An information processing system according to Example 11 is an information processing system for weighting an evaluation item for evaluating an evaluation target, and includes: a text information obtainer that obtains, as text information, information expressed by one or more persons in an organization to which the one or more persons belong; a topic obtainer that obtains one or more topics related to the text information by analyzing the text information; and a weighting unit that weights the evaluation item based on one or more similarity degrees between the evaluation item and the one or more topics.

Thus, by weighting the evaluation item based on the one or more similarity degrees between the evaluation item and the one or more topics obtained based on the text information, the evaluation target can be evaluated in accordance with the value system of the organization or the like.

A recording medium according to Example 12 is a non-transitory computer-readable recording medium having recorded thereon a program for causing a computer to execute the information processing method according to any one of Examples 1 to 10.

Accordingly, the above-described information processing method can be executed by the computer in accordance with the program of the recording medium.

It should be noted that these general or specific aspects may be realized as a system, a device, a method, an integrated circuit, a computer program, or a non-transitory computer readable recording medium such as a CD-ROM, or any given combination thereof.

Hereinafter, an embodiment will be described with reference to the Drawings. It should be noted that the embodiment described below shows a general or specific example. The numerical values, shapes, materials, constituent elements, the arrangement and connection of the constituent elements, steps, the processing order of the steps etc. shown in the following embodiment are mere examples, and therefore do not limit the scope of the Claims.

### (Embodiment)

### [Configuration of Information Processing System]

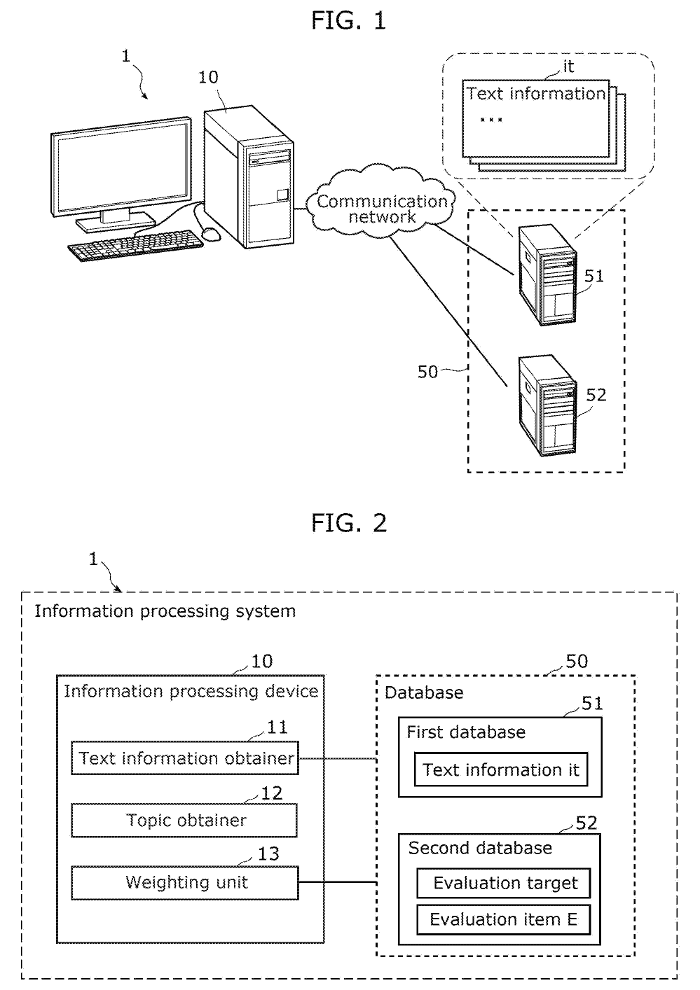

A configuration of an information processing system according to an embodiment will be described with reference to FIG. 1 to FIG. 8.

FIG. 1 is a schematic diagram illustrating information processing system 1 according to the embodiment. FIG. 2 illustrates a block configuration of information processing system 1 and information processing device 10 included in information processing system 1.

As illustrated in FIG. 1 and FIG. 2, information processing system 1 includes information processing device 10 and database 50.

Information processing device 10 and database 50 are connected to each other via a communication network.

For example, information processing device 10 is a computer device, receives and outputs various types of information, and performs calculation processing. Information processing device 10 accesses database 50 to obtain necessary information.

For example, database 50 is a computer device, and receives, outputs, edits, and stores various types of information. It should be noted that database 50 also includes an external storage device such as a network attached storage (NAS).

Database 50 includes first database 51 and second database 52. For example, first database 51 and second database 52 are provided inside a facility managed by an organization such as a company.

First database 51 stores information expressed by one or more persons in the organization. The information expressed by the one or more persons is stored as, for example, text information it, an audio file, or an image file. The audio file or the image file may be stored in a state where the audio file or the image file has been converted into text information (a text file).

For example, second database 52 is a technology planning and management database and stores: an evaluation target such as a theme of research and development; and information related to evaluation item E for evaluating the evaluation target.

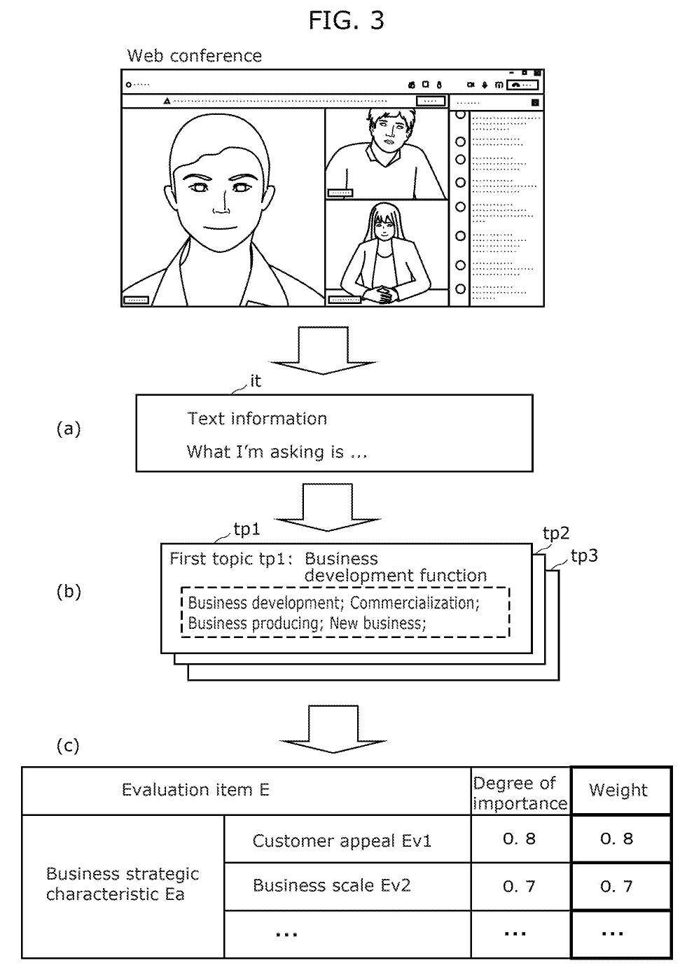

FIG. 3 illustrates an overview of processes performed by information processing device 10.

In (a) of FIG. 3, text information it that is information expressed by one or more persons in a web conference is illustrated. In (b) of FIG. 3, topics tp1, tp2, and tp3 extracted based on text information it are illustrated. In (c) of FIG. 3, an example in which evaluation items E are each weighted based on topics tp. Information processing device 10 extracts, from text information it that is information expressed by one or more persons in an organization, topics tp1 to tp3 that are related to text information it, and weights evaluation item E based on topics tp1 to tp3.

As illustrated in FIG. 2, information processing device 10 includes text information obtainer 11, topic obtainer 12, and weighting unit 13.

Text information obtainer 11 is a processing circuit that obtains text information it. Text information obtainer 11 obtains, as text information it, information expressed by one or more persons in an organization to which the one or more persons belong.

The information expressed by the one or more persons is, for example, information expressed by one or more persons when a plurality of persons communicate with each other, and includes information spoken by the one or more persons and information documented by the one or more persons.

Text information it is information obtained from information expressed by one or more persons in at least one of a meeting, an online chat, or an e-mail transmission within the organization. The information expressed by the one or more persons is stored as in-house intellectual property information in first database 51 at any time.

Text information obtainer 11 obtains, as text information it, the information expressed by the one or more persons from first database 51. Text information it obtained by text information obtainer 11 is outputted to topic obtainer 12.

Topic obtainer 12 is a processing circuit that obtains topic tp. Topic obtainer 12 obtains topics tp related to text information it by analyzing text information it. Topic tp is a latent semantic category, is called a “latent topic” or simply a “topic”, and is a term that concisely and comprehensively represents semantic content indicated by a plurality of words. Topic tp may be a word present in text information it or a term formed by compounding and processing a plurality of words present in text information it.

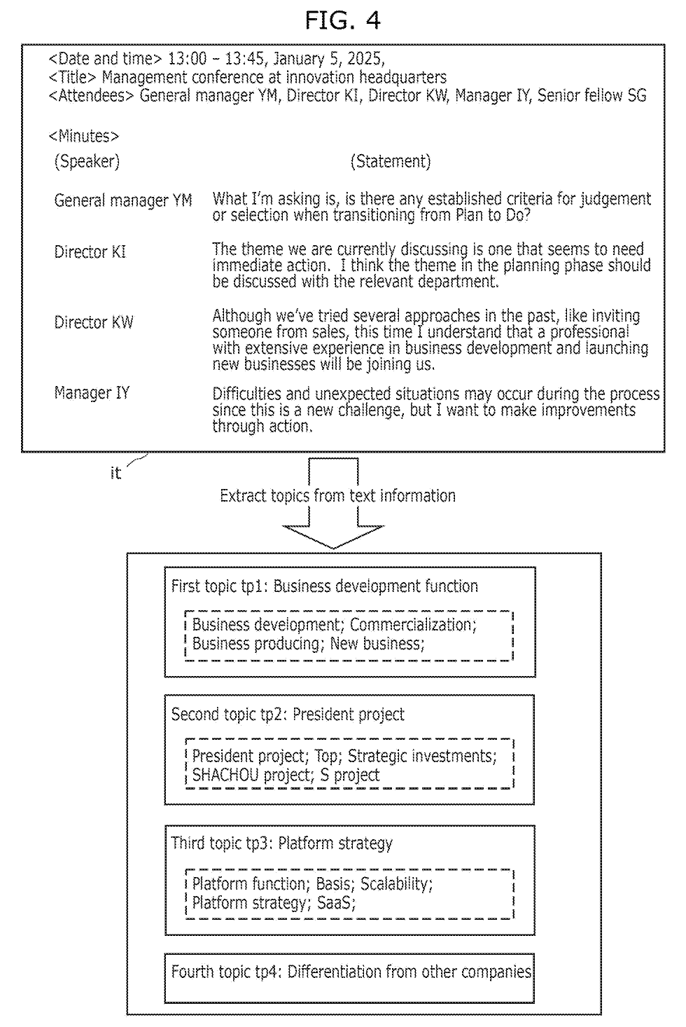

FIG. 4 illustrates text information it obtained from information expressed by persons, and topics tp extracted from text information it.

In the example illustrated in FIG. 4, a theme related to management of a department in a company is discussed in a meeting, and information expressed by persons during the meeting is illustrated as text information it. The information expressed by the persons during the meeting includes information related to an online chat or an e-mail transmission during the meeting.

In the example illustrated in FIG. 4, from text information it obtained from the meeting, “business development function” is extracted as first topic tp1, “president project” is extracted as second topic tp2, “platform strategy” is extracted as third topic tp3, and “differentiation from other companies” is extracted as fourth topic tp4. In this example, the topics are arranged from top to bottom in descending order of their probability of belonging to text information it. It should be noted that a probability of a topic belonging to text information it is a probability that text information it includes a term corresponding to the topic. Although FIG. 4 illustrates four topics, the number of topics extracted may be five or more. The number of topics extracted from text information it may be at least one and at most twenty, for example.

Topic obtainer 12 extracts topics tp from text information it by analyzing text information it using topic modeling that is an example of latent semantic analysis. Topic modeling is a natural language processing method of classifying a plurality of items of text information it into categories based on the content included in each of the plurality of items of text information it, interpreting the meaning of each word present in each of the plurality of items of text information it in view of the category classified, and extracting one or more topics from each of the plurality of items of text information it. For example, a term “platform” included in text information it in FIG. 4 is not interpreted as a platform at a train station but is interpreted as a term used in a category of business strategy based on the context of text information it, and then is extracted as a topic.

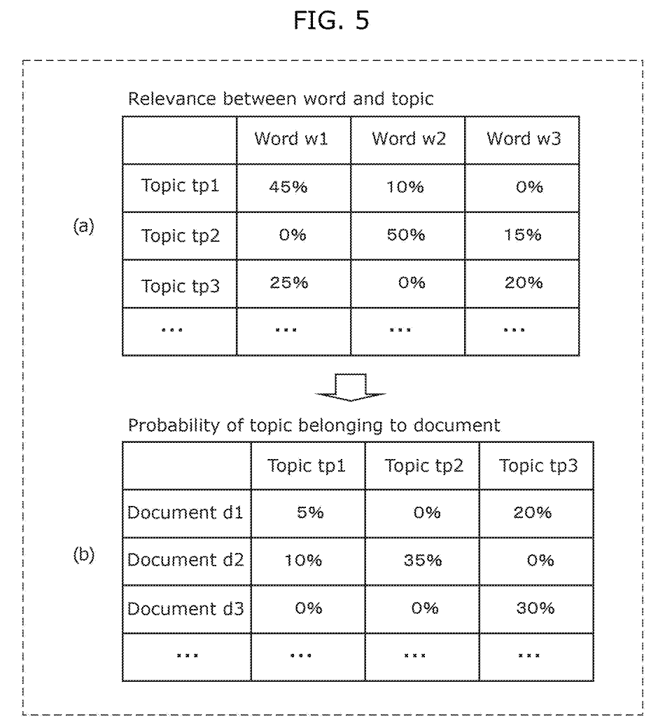

FIG. 5 illustrates an example of topic modeling used for analyzing text information it.

As illustrated in (a) in FIG. 5, topic tp is represented by a combination of a plurality of words. For example, (a) in FIG. 5 illustrates that the probability of word w1 belonging to topic tp1 is 45%, the probability of word w2 belonging to topic tp1 is 10%, and the probability of word w3 belonging to topic tp1 is 0%.

As illustrated in (b) in FIG. 5, a document that is text information it includes a plurality of topics. For example, (b) in FIG. 5 illustrates that the probability of topic tp1 belonging to document d1 is 5%, the probability of topic tp2 belonging to document d1 is 0%, and the probability of topic tp3 belonging to document d1 is 20%.

By performing topic modeling, a plurality of words that mean the same content can be treated as a single topic tp and the latent meaning of a document can be understood.

It should be noted that topic obtainer 12 may exclude, from topics tp related to text information it, a topic that cannot be related to evaluation item E, and obtain one or more topics tp. The topic that cannot be related to evaluation item E is, for example, a proper noun such as the name of a person or the name of a place, or an entertainment that is not related to business. In the example illustrated in FIG. 4, second topic tp2 that is “president project” is excluded as a topic that cannot be related to evaluation item E.

Hereinafter, an example in which topic obtainer 12 excludes second topic tp2 and obtains topics tp1, tp3, and tp4 as a plurality of topics related to text information it will be described.

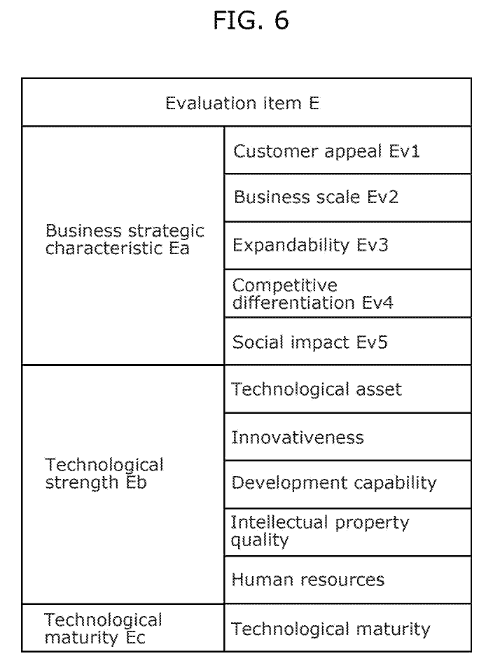

FIG. 6 illustrates an example of evaluation items E for evaluating an evaluation target.

The evaluation target according to the present embodiment is, for example, a theme of research and development conducted by a company. The evaluation target is evaluated based on evaluation items E such as business strategic characteristic Ea, technological strength Eb, and technological maturity Ec. For example, among evaluation items E, business strategic characteristic Ea is subdivided into customer appeal Ev1 (compatibility with customer mission), business scale Ev2, expandability Ev3 (expandability of technology), competitive differentiation Ev4, social impact Ev5 (impact on the market), and the like.

Customer appeal Ev1, business scale Ev2, expandability Ev3, competitive differentiation Ev4, and social impact Ev5 are an example of evaluation items E. Business strategic characteristic Ea, technological strength Eb, and technological maturity Ec are an example of evaluation items E.

Weighting unit 13 performs the following process for weighting each of subdivided evaluation items E.

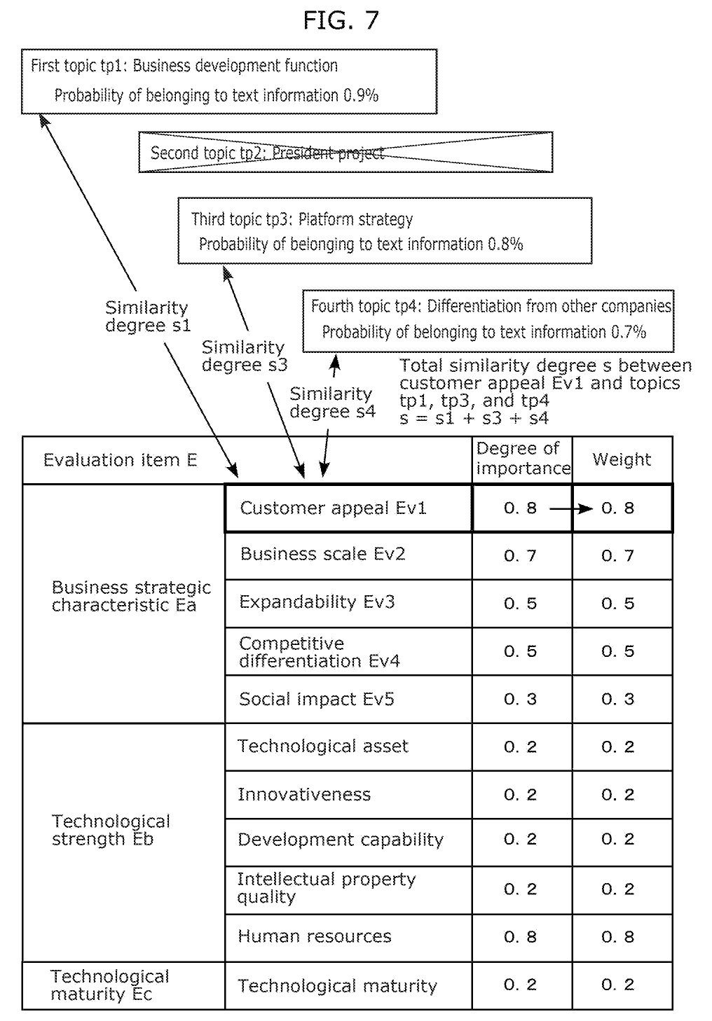

FIG. 7 illustrates an example in which evaluation items E are weighted based on topics tp.

As illustrated in FIG. 7, weighting unit 13 weights evaluation item E based on similarity degrees between evaluation item E and topics tp.

A similarity degree between evaluation item E and topic tp is derived by a method using a cosine (cos) similarity. A cosine similarity is a numerical representation of how closely two vectors face in the same direction. Specifically, a cosine similarity is what represents an angle between two vectors as a cosine value, and can be calculated by using the inner product of the two vectors as a numerator and the magnitude of the two vectors as a denominator. For example, a similarity degree is low when a cosine similarity is 0, and a similarity degree is high when a cosine similarity is 1.

It should be noted that weighting unit 13 performs language conversion using word to vector (Word2vec) before calculating a similarity degree. Word2vec is a natural language processing method for converting a term in a sentence into a numerical vector to comprehend its meaning. Each of the term “topic tp” and the term “evaluation item E” is a term in the present embodiment. By performing conversion using Word2vec, calculation between two terms that are topic tp and evaluation item E, specifically, calculation of a similarity degree between the two terms is made possible.

For example, information processing device 10 calculates similarity degrees s1, s3, and s4 between customer appeal Ev1 and topics tp1, tp3, and tp4, calculates total similarity degree s between customer appeal Ev1 and topics tp1, tp3, and tp4 based on similarity degrees s1, s3, and s4, and weights customer appeal Ev1 based on total similarity degree s. In the example illustrated in FIG. 7, the sum of similarity degree s1 between “business development function” and “customer appeal”, similarity degree s3 between “platform strategy” and “customer appeal”, and similarity degree s4 between “differentiation from other companies” and “customer appeal” is total similarity degree s of customer appeal Ev1.

It should be noted that weighting unit 13 may derive the degree of importance of customer appeal Ev1 based on similarity degrees s1, s3, and s4 and the probability of each of topics tp belonging to text information it, and may weight customer appeal Ev1 according to the degree of importance.

FIG. 7 illustrates an example in which the probability of topic tp1 belonging to text information it is 0.9%, the probability of topic tp3 belonging to text information it is 0.8%, and the probability of topic tp4 belonging to text information it is 0.7%. In this case, weighting unit 13 derives the degree of importance of customer appeal Ev1 by multiplying similarity degrees s1, s3, and s4 by the probability of topic tp1 belonging to text information it, the probability of topic tp3 belonging to text information it, and the probability of topic tp4 belonging to text information it, respectively, and weights customer appeal Ev1 according to the degree of importance derived. Although the value of weight and the value of a degree of importance are the same in FIG. 7, these values do not need to be the same and the value of weight may be proportional to the value of a degree of importance. The value of weight may be 1 at maximum and may be represented as a ratio to 1.

Although customer appeal Ev1 has been described above as an example, weighting can be similarly performed on business scale Ev2, expandability Ev3, competitive differentiation Ev4, and social impact Ev5.

An evaluation result regarding business strategic characteristic Ea of an evaluation target reflects the above-described values of weight, and is derived based on (Equation 1) shown below.

Evaluation result = (α1×Ev1+α2×Ev2+α3×Ev3+α4×Ev4+α5×Ev5)/5 ... (Equation 1)

where each of α1, α2, α3, α4, and α5 denotes the value of weight, and

0<α1, α2, α3, α4, α5<1.0 is satisfied.

Evaluation results regarding technological strength Eb and technological maturity Ec of the evaluation target can be derived similarly.

Information processing system 1 according to the present embodiment includes: text information obtainer 11 that obtains, as text information it, information expressed by one or more persons in an organization to which the one or more persons belong; topic obtainer 12 that obtains one or more topics tp related to text information it by analyzing text information it; and weighting unit 13 that weights evaluation item E based on one or more similarity degrees s between evaluation item E and one or more topics tp.

Thus, by weighting evaluation item E based on one or more similarity degrees s between evaluation item E and one or more topics tp obtained based on text information it, an evaluation target can be evaluated in accordance with a value system of the organization.

It should be noted that although an example in which topic tp is a term formed based on a plurality of words has been described, the present disclosure is not limited to this example.

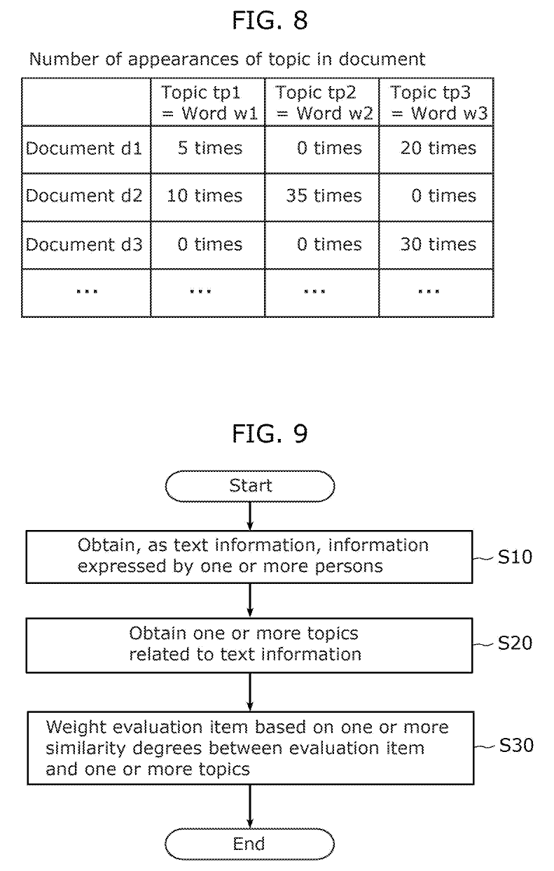

FIG. 8 illustrates another example of topic modeling.

FIG. 8 illustrates that, in document d1, the number of appearances of topic tp1 (= word w1) is five, the number of appearances of topic tp2 (= word w2) is zero, the number of appearances of topic tp3 (= word w3) is twenty. Topic obtainer 12 may merely analyze text information it by obtaining the number of appearances of each of a plurality of words in text information it, and obtain a word having a large number of appearances among the plurality of words.

Moreover, topic obtainer 12 may make a determination, for each of a plurality of words included in text information it, as to whether the word is based on positive information or negative information, and obtain a topic based on the determination. Whether a word included in text information it is based on positive information or negative information may be determined by, for example, a sentiment analysis using feature transformation of text data using a transformer-based machine learning model for pre-training of natural language processing such as bidirectional encoder representations from transformers (BERT).

For example, when text information it includes the negative information “platform strategy is meaningless” and the word “platform_strategy” is used for counting its number of appearances or calculating its probability of belonging to text information it, data analysis is performed in a way different from what is intended by the context. Then, when topic obtainer 12 determines that information included in text information it is based on negative information, text information it is not analyzed based on the negative information, for example.

### [Information Processing Method]

An information processing method according to the embodiment will be described with reference to FIG. 9.

FIG. 9 is a flowchart illustrating the information processing method according to the embodiment.

The information processing method is a method for weighting an evaluation item for evaluating an evaluation target. The evaluation target is, for example, a theme of research and development that is promoted by a company with investments for the future.

First, information processing device 10 obtains, as text information it, information expressed by one or more persons in an organization (step S10). For example, information processing device 10 accesses first database 51 to obtain text information it.

Text information it is information expressed by one or more persons when a plurality of persons communicate with each other. For example, text information it is information obtained from information expressed by one or more persons in at least one of a meeting, an online chat, or an e-mail transmission within an organization.

Next, information processing device 10 obtains one or more topics tp related to text information it by analyzing text information it (step S20). For example, information processing device 10 analyzes a latent meaning of text information it using topic modeling and obtains one or more topics tp.

It should be noted that information processing device 10 may analyze text information it by obtaining the number of appearances of each of a plurality of words in text information it, and obtain, as one or more topics, one or more words each having a large number of appearances among the plurality of words.

Information processing device 10 may exclude, from topics tp related to text information it, a topic that cannot be related to evaluation item E, and obtain one or more topics tp. Information processing device 10 may perform an analysis, for each of a plurality of words included in text information it, as to whether the word is based on positive information or negative information, and obtain one or more topics tp based on the analysis. In this case, when topic tp is based on negative information, information processing device 10 does not necessarily analyze text information it that is based on negative information.

Next, information processing device 10 weights evaluation item E based on one or more similarity degrees between evaluation item E and one or more topics tp (step S30). It should be noted that information processing device 10 accesses second database 52 to obtain evaluation item E.

For example, information processing device 10 calculates similarity degrees s1, s3, and s4 between evaluation item E and topics tp1, tp3, and tp4, calculates total similarity degree s between evaluation item E and topics tp1, tp3, and tp4 based on similarity degrees s1, s3, and s4, and weights evaluation item E based on total similarity degree s.

It should be noted that information processing device 10 may derive the degree of importance of evaluation item E based on the probability of each of topics tp belonging to text information it in addition to the above-described similarity degrees s1, s3, and s4, and may weight evaluation item E according to the degree of importance.

According to the information processing method, by weighting evaluation item E based on one or more similarity degrees s between evaluation item E and one or more topics tp obtained based on text information it, an evaluation target can be evaluated in accordance with a value system of the organization. The evaluation target is evaluated after evaluation item E is weighted. Accordingly, the evaluation target can be evaluated in accordance with the value system of the organization.

### (Other Embodiments)

Although an aspect of an information processing system or the like has been described according to the embodiment, the aspect of the information processing system or the like is not limited to the embodiment. Modifications conceivable by those skilled in the art may be made to the embodiment and the constituent elements in the embodiment may be arbitrarily combined.

Although an example in which evaluation item E is weighted by using the probability of topic tp belonging to text information it has been described above, the present disclosure is not limited to this example. For example, information processing device 10 may set the degree of importance of topic tp based on the job position or role within an organization of each of one or more persons who has expressed information, and may weight evaluation item E based on the degree of importance of topic tp.

Moreover, for example, a process performed by a particular constituent element in the embodiment may be performed by a different constituent element instead of the particular constituent element. Furthermore, the processing order of processes may be changed, and the processes may be performed in parallel. Furthermore, ordinal numbers such as first and second used for description of the embodiment may be appropriately exchanged, removed, or newly added. These ordinal numbers do not necessarily correspond to significant order, and may be used to distinguish between elements.

The information processing method may be executed by an optional system or an optional device. In other words, the information processing method may be executed by the above-described information processing system or the like, or may be executed by another system or device.

For example, part or all of the information processing method may be executed by a computer that includes a processor, a memory, an input/output circuit, or the like. In this case, the information processing method may be executed by the computer executing a program for causing the computer to execute the information processing method.

Moreover, the above-described program may be recorded on a non-transitory computer-readable recording medium such as a CD-ROM.

Furthermore, each of the constituent elements included in the information processing system or the like may be configured as dedicated hardware, general-purpose hardware that executes the above-described program, or a combination thereof. Furthermore, the general-purpose hardware may include: a memory on which the program is recorded; and a general-purpose processor or the like that executes the program by reading out the program from the memory. Here, the memory may be a semiconductor memory, a hard disk, or the like, and the general-purpose processor may be a central processing unit (CPU) or the like.

Moreover, the dedicated hardware may include a memory and a dedicated processor or the like. For example, the dedicated processor may execute the above-described information processing method by referring to the memory.

Moreover, each of the constituent elements included in the information processing system may be an electric circuit. These electric circuits may constitute a single circuit as a whole or may be individual circuits. Moreover, these electric circuits may be compatible with dedicated hardware or general-purpose hardware that executes the above-described program or the like.

### Industrial Applicability

The present disclosure is applicable to an evaluation method or the like for performing an evaluation in accordance with a value system of an organization or a target organizational image.

1. An information processing method for weighting an evaluation item for evaluating an evaluation target, the information processing method comprising:
obtaining, as text information, information expressed by one or more persons in an organization to which the one or more persons belong;
obtaining one or more topics related to the text information by analyzing the text information; and
weighting the evaluation item based on one or more similarity degrees between the evaluation item and the one or more topics.

2. The information processing method according to claim 1, wherein
in the weighting, a degree of importance of the evaluation item is derived based on the one or more similarity degrees and a probability of each of the one or more topics belonging to the text information, and the evaluation item is weighted according to the degree of importance.

3. The information processing method according to claim 1, wherein
the one or more topics obtained in the obtaining of one or more topics are a plurality of topics related to the text information, and
in the weighting, similarity degrees between the evaluation item and the plurality of topics are obtained, a total similarity degree between the evaluation item and the plurality of topics is obtained based on the similarity degrees, and the evaluation item is weighted based on the total similarity degree.

4. The information processing method according to claim 1, wherein
the text information is information expressed by the one or more persons when a plurality of persons including the one or more persons communicate with each other.

5. The information processing method according to claim 1, wherein
the text information is information obtained from information expressed by the one or more persons in at least one of a meeting, an online chat, or an e-mail transmission within the organization.

6. The information processing method according to claim 1 , wherein
in the obtaining of one or more topics, the one or more topics are obtained by analyzing a latent meaning of the text information using topic modeling.

7. The information processing method according to claim 1, wherein
in the obtaining of one or more topics, the text information is analyzed by obtaining a total number of appearances of each of a plurality of words in the text information, and one or more words each having a large number of appearances among the plurality of words are obtained as the one or more topics.

8. The information processing method according to claim 1, wherein
in the obtaining of one or more topics, the one or more topics are obtained by excluding, from a plurality of topics related to the text information, a topic that cannot be related to the evaluation item.

9. The information processing method according to claim 1, wherein
in the obtaining of one or more topics, a determination is made, for each of a plurality of words included in the text information, as to whether the word is based on positive information or negative information, and the one or more topics are obtained based on the determination.

10. The information processing method according to claim 9, wherein
in the obtaining of one or more topics, when information included in the text information is determined to be based on negative information, the text information is not analyzed based on the negative information.

11. An information processing system for weighting an evaluation item for evaluating an evaluation target, the information processing system comprising:
a text information obtainer that obtains, as text information, information expressed by one or more persons in an organization to which the one or more persons belong;
a topic obtainer that obtains one or more topics related to the text information by analyzing the text information; and
a weighting unit that weights the evaluation item based on one or more similarity degrees between the evaluation item and the one or more topics.

12. A non-transitory computer-readable recording medium having recorded thereon a program for causing a computer to execute the information processing method according to claim 1 .
